(19) United States
(12) Patent Application Publication
(10) Pub. No.: US 2007/0121660 A1
(43) Pub. Date: May 31, 2007

(54) Load balanced architecture of cascading of MxM Ethernet packet based switches that supports up to 4 levels of QoS

(76) Inventors: Robert Ayrapetian, Morgan Hill, CA (US); Serob Douvalian, Daly City, CA (US)

Correspondence Address: STEVENS LAW GROUP, P.O. BOX 1667, SAN JOSE, CA, 95109, US

(21) Appl. No.: 11/593,807

(22) Filed: Nov. 6, 2006

Related U.S. Application Data
(60) Provisional application No. 60/733,963, filed on Nov. 4, 2005.
(60) Provisional application No. 60/733,966, filed on Nov. 4, 2005.

(51) Int. Cl. H04L 12/56

(52) U.S. Cl. 370/411

(57) ABSTRACT

A network switch is provided that includes a bank of input switches configured to receive variable length data packets; a bank of central switches configured to receive packets from the input switches in a distributed manner; and a bank of output switches configured to receive and output variable length packets from the bank of central switches.

### CLAIM OF PRIORITY

This application claims the benefit of U.S. provisional patent application Ser. No. 60/733,963, filed Nov. 4, 2005.

This application also claims the benefit of U.S. provisional patent application Ser. No. 60/733,966, filed Nov. 4, 2005.

This application also claims the benefit of priority of U.S. patent application Ser. No. 11/400,367, filed Apr. 6, 2006, which claims the benefit of U.S. provisional patent application Ser. No. 60/669,028, filed Apr. 6, 2005.

This application also claims the benefit of U.S. provisional patent application Ser. No. 60/634,631, filed Dec. 12, 2004.

### BACKGROUND

Many M×M type switches exist in the art, but all suffer from the overloading or bottlenecking of data packets. Data packets are typically set in standard sizes and allocated to output buffers and switches in these standard sizes. The invention is directed to an improved switch to alleviate such bottlenecking.

### BRIEF DESCRIPTION OF THE DRAWINGS

FIG. 1 is a diagrammatic view of a network switch according to the invention.

### DETAILED DESCRIPTION

Assumtion:

Each M×M switch supports variable length Ethernet packets with maximum packet size of 1518 bytes.

Each M×M switch supports up to 4 levels of QoS.

1. Cascade Architecture

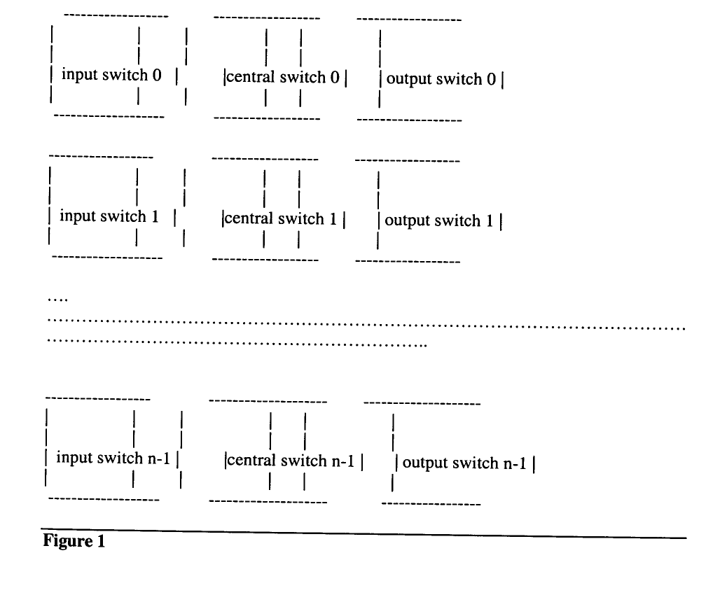

Let n is one of divisors of the number M, and N=M*n. In this case (as shown below) the Clo's architecture may be used to create cascade of 3*n M×M switches that functions as N×N switch. See FIG. 1.

M/n consecutive outputs of each input switch are connected to M/n consecutive inputs of the same central switch.

Let m is the number of the input switch
k is the number of the central switch
r is the number of the output switch

Outputs k*M/n, k*M/n+1, . . . k*M/n+n−1 of the input switch m are connected to inputs m*M/n, m*M/n+1, . . . , m*M/n+n−1 of the central switch k.

In the same manner M/n consecutive outputs of each central switch are connected to M/n consecutive inputs of the same output switch.

Outputs r*M/n, r*M/n+1, . . . r*M/n+n−1 of the central switch k are connected to inputs k*M/n, k*M/n+1, . . . , k*M/n+n−1 of the output switch r.

### EXAMPLE OF CLO'S NETWORK ARCHITECTURE

For example in case M=32,n=4, N=128 we have connections

| Input switch m = 0 | Central switch k = 0 | | Output switch r = 0 |
|---|---|---|---|
| Outputs 0, 1, . . . , 7 | Inputs 0, 1, . . . , 7 | Outputs 0, 1, . . . , 7 | Inputs 0, 1, 2 . . . 7 |
| Input switch m = 1 | Central switch k = 0 | | Output switch r = 1 |
| Outputs 0, 1, . . . , 7 | Inputs 8, 9, . . . , 15 | Outputs 8, 9, . . . , 15 | Inputs 0, 1, 2 . . . 7 |
| Input switch m = 2 | Central switch k = 0 | | Output switch r = 2 |
| Outputs 0, 1, . . . , 7 | Inputs 16, 17, . . . , 23 | Outputs 16, 17, . . . , 23 | Inputs 0, 1, 2 . . . 7 |
| Input switch m = 3 | Central switch k = 0 | | Output switch r = 3 |
| Outputs 0, 1, . . . , 7 | Inputs 24, 25, . . . , 31 | Outputs 24, 25, . . . , 31 | Inputs 0, 1, 2 . . . 7 |
| Input switch m = 0 | Central switch k = 1 | | Output switch r = 0 |
| Outputs 8, 9, . . . , 15 | Inputs 0, 1, . . . , 7 | Outputs 0, 1, . . . , 7 | Inputs 8, 9, . . . 15 |
| Input switch m = 1 | Central switch k = 1 | | Output switch r = 1 |
| Outputs 8, 9, . . . , 15 | Inputs 8, 9, . . . , 15 | Outputs 8, 9, . . . , 15 | Inputs 8, 9, . . . , 15 |
| Input switch m = 2 | Central switch k = 1 | | Output switch r = 2 |
| Outputs 8, 9, . . . , 15 | Inputs 16, 17, . . . , 23 | Outputs 16, 17, . . . , 23 | Inputs 8, 9, . . . , 15 |
| Input switch m = 3 | Central switch k = 1 | | Output switch r = 3 |
| Outputs 8, 9, . . . , 15 | Inputs 24, 25, . . . , 31 | Outputs 24, 25, . . . , 31 | Inputs 8, 9 . . . , 15 |

and so on.

Each stage has 4 single switch. The out ports in each single switch combined in 4 groups:
GROUP 0 Ports: 0, . . . ,7
GROUP 1 Ports: 8, . . . ,15
GROUP 2 Ports: 16, . . . 23
GROUP 3 Ports: 24, . . . ,31

The First Group in First Switch in First Stage we will denote as I00.

THREE STAGE CLOSE NETWORK

| SW# | SATGE I | SATGE II | STAGE III |
|---|---|---|---|
| 0 | I00 | II00 | III00 |
| | I01 | II01 | III01 |
| | I02 | II02 | III02 |
| | I03 | II03 | III03 |
| 1 | I10 | II10 | III10 |
| | I11 | II11 | III11 |
| | I12 | II12 | III12 |
| | I13 | II13 | III13 |
| 2 | I20 | II20 | III20 |
| | I21 | II21 | III31 |
| | I22 | II22 | III32 |
| | I23 | II23 | III33 |
| 3 | I30 | II30 | III30 |
| | I31 | II31 | III31 |
| | I32 | II32 | III32 |
| | I33 | II33 | III33 |

Let N=32*n, and N=128, n=4 (each stage has 4 switches).

Let m,k,r=0, 1, . . . , n−1. In our case m, k, r=0, 1, 2, 3, are numbers of the First, second and third stage switches.

Then,
1. A 32/n=8 consecutive output ports of the First Stage
   32*m+8*k+p
   are connected to 8 consecutive input ports of the Second Stage
   32*k+8*m+p where m,k=0,1,2,3 and p=0,1,2, . . . ,7
2. A 32/n=8 consecutive output ports of the Second Stage
   32*k+8*r+p
   are connected to 8 consecutive input ports of the Third Stage
   32*r+8*k+p where r,k=0,1,2,3 and p=0,1,2, . . . ,7

According to above equations we get

Outputs of Stage I are connected to the inputs of Stage II as follows:
Group Iab→IIba, where a,b=0,1,2,3

Outputs of Stage II are connected to the inputs of Stage III as follows:
Group IIab→IIIba, where a,b=0, 1, 2, 3

Hence, the following will be the clo's network path:
I00→II00→III00
I10→II01→III10
I20→II02→III20
I30→II03→III30
I01→II10→III01
I11→II11→III11
I21→II12→III21
I31→II13→III31
I02→II20→III02
I12→II21→III12
I22→II22→III22
I32→II23→III32
I03→II30→III03
I13→II31→III13
I23→II32→III23
I33→II33→III33
   2. Switching Algorithms.

Any incoming packet to some port of the input switch m may be send through any one of its M output ports to some central switch k, and then through one of the M/n output ports of this central switch to corresponding output switch.

So there are M*M/n routs from a given input switch m to a given output switch r. It is necessary to send packets from input switch m to output switch r so that for any given interval flow of information is uniformly distributed over possible M*M/n routs. Such uniform distribution of the flow from input switch m to output switch r is equivalent to uniform distribution of the flow through M output ports of the input switch m, and uniform distribution of the flow through M/n output ports of each central switch connected to output switch r.

2.1 Switching Algorithm for the Input Switch m.

Let for example M=32 and n=4.

Input ports of the input switch m are divided into n=4 groups. Each group includes M/n=8 consecutive ports:
{0,1, . . . ,7}, {8,9, . . . ,15}, {16,17, . . . ,23}, {24,25, . . . ,31}.

Switching algorithm is based on parameters:
L(g,r,p)—flow of information in bytes from input ports of group g, to output switch r through output port p of the input switch m.
L(g,r)=min {L(g,r,p) minimal value of the flow
   0<=p<=M
Lnorm(g,r,p)=L(g,r,p)−L(g,r)—normalized flow in bytes
P(g,r)—number of the output port of the input switch m that will be used for sending incoming packet to one of input ports of group g with destination output switch r.
N(g,r)—repetition parametr.

At start L(g,r,p)=0, P(g,r)=0; N(g,r)=3;

Each time a segment of some packet is moved from input buffer into intermediate buffer the corresponding flow L(g,r,p) is incremented by 64 (or 32).

Periodically(in manner discussed below) minimal flow L(g,r) is calculated, and L(g,r,p) is replaced by its normalized value.

Incoming packet to one of ports of the group g with a destination output port r is switched to output port P(g,r). Now there are two possibilities
(L(g,r,p)>=Limit)∥(N(g,r)==0) a)

Normalized flow is not too small, or three packets are send to the same port P(g,r). P(g,r) is increased by 1 in circular manner
P(g,r)=P(g,r)+1 if P(g,r)<M−1
0 if P(g,r)=M−1

The repetition parameter is set to Repeat
N(g,r)=Repeat;
(L(g,r,p)<Limit)&&(N(g,r)>0) b)

The next incoming packet must be sent to the same output port. N(g,r) is decreased by 1
N(g,r)−−;
C Simulation Model show that parameters Limit and Repeat may be equal to 1000, and 3.

Let us now consider normalization of the flow.
Old value of L(g,r) is used for normalization of the flow L(g,r,p), and new value of L(g,r) is calculated in parallel. Because L(g,r,p) is corrected also when segments of corresponding packets are moved into intermediate buffer it is necessary to exclude possible conflicts.
   2.2 Switching Algorithm for the Central Switch k.

In case of central switch packets with destination output switch r must be uniformly distributed to Min outputs. So in case n=M there is now distribution problem. If n<M the algorithm used for input switch m must be used central switch k, but now P(g,r) has to change so that it covers M/n output ports in circular manner.

2.3 Switching Algorithm for the Output Switch r.

As shown above the input switches and central switches deliver packets based on the number r of destination output switch equal to quotient from division the number of the destination port j by M. In case M=32
r=j>>5;

Output switch r on its turn switches packets with destination port j to its output port j−r*M equal to remainder from division the number of the destination port j by M. In case M=32
j−r*M=(j&31);

### 3 CONCLUSION

The cascading M×M switches is based on 3 types of M×M switches that switch packets with destination j based on numbers M, and n.

1. A network switch comprising:
a bank of input switches configured to receive variable length data packets;
a bank of central switches configured to receive packets from the input switches in a distributed manner; and
a bank of output switches configured to receive and output variable length packets from the bank of central switches.
